(19) United States
(12) Patent Application Publication
(10) Pub. No.: US 2009/0220768 A1
(43) Pub. Date: Sep. 3, 2009

(54) REPOSITIONABLE SELF-ADHESIVE GIFTWRAP

(75) Inventors: Karl E. Guyler, Bucyrus, KS (US); Larry E. Williams, Lenexa, KS (US); Nathan P. Garrett, Leavenworth, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HALLMARK CARDS, INCORPORATED, Kansas City, MO (US)

(21) Appl. No.: 12/040,263

(22) Filed: Feb. 29, 2008

(51) Int. Cl. B32B 7/12; B32B 5/16; B05D 5/10

(52) U.S. Cl. 428/323; 428/352; 427/208.8

(57) ABSTRACT

Repositionable self-adhesive giftwrap for decoratively wrapping an article and methods for manufacturing the same are disclosed. In embodiments, the giftwrap includes a substrate sheet having a first surface and a second surface. A decorative ink layer is applied to the first surface and a release coating layer is applied to the first surface over the decorative ink layer. The decorative ink layer resides between the substrate sheet and the release coating layer. Further, the giftwrap includes an adhesive layer applied to the second surface of the substrate sheet that is configured to adhere the giftwrap to the article. The release coating layer allows the adhesive layer of the second surface to be removed from the release coating layer of the first surface without removing portions of the decorative ink layer where the giftwrap overlaps and where the adhesive layer of the second surface of a portion of the substrate contacts release coating of the first surface of another portion of the substrate.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

Embodiments of the present invention provide repositionable self-adhesive giftwrap for decoratively wrapping an article and methods for manufacturing repositionable self-adhesive giftwrap. In embodiments, the giftwrap includes a substrate sheet having a first surface and a second surface. The first surface is an outwardly facing upper surface and the second surface is and inwardly facing inner surface when the giftwrap is applied to the article. The giftwrap also includes a decorative ink layer applied to the first surface of the substrate and a release coating layer applied to the first surface over the decorative ink layer. Thus, the decorative ink layer resides between the substrate sheet and the release coating layer. Further, the giftwrap includes an adhesive layer applied to the second surface of the substrate sheet. The adhesive layer adheres the giftwrap to the article. The release coating layer is configured to allow the adhesive side of the substrate to be removed from the release coat side of the substrate without removing portions of the decorative ink layer when the giftwrap has overlapped and been secured to itself, such as when it is on a roll or when it needs to be repositioned during the wrapping of a package.

In one aspect, the present invention is directed to repositionable self-adhesive giftwrap for decoratively wrapping an article. In this aspect, the giftwrap includes a substrate sheet having a first surface and a second surface. The first surface is the outer or upper surface and the second surface is the inner or lower surface when the giftwrap is applied to the article. The giftwrap also includes a decorative ink layer applied to the first surface of the substrate and a release coating layer applied to the first surface over the decorative ink layer. Thus, the decorative ink layer resides between the substrate sheet and the release coating layer. Further, the giftwrap includes an adhesive layer applied to the second surface of the substrate sheet. The adhesive layer adheres the giftwrap to the article and/or to itself as needed. Still further, the release coating layer is configured to allow the adhesive side of the giftwrap to be removed from engagement with the release coat side without removing portions of the decorative ink layer.

In another aspect, the present invention is directed to a method for manufacturing repositionable self-adhesive giftwrap for decoratively wrapping an article. The method includes applying a decorative ink layer to a first surface of a substrate sheet. The substrate sheet has a first surface that is an outer or upper surface and a second or lower surface that is an inner surface when the giftwrap is applied to an article. The method further includes applying a release coating layer to the first surface of the substrate sheet over the decorative ink layer. Thus, the decorative ink layer resides between the substrate sheet and the release coating layer. Further, the method includes applying an adhesive layer to the second surface of the substrate such that the adhesive layer adheres the giftwrap to the article. In this aspect, the release coating layer is configured to allow repeated removal of abutting contact between the adhesive side of the giftwrap and the release coat side without removing portions of the decorative ink layer.

In yet another aspect, the release coating layer provides for a first uniform coat on the first surface of the substrate sheet and the adhesive layer provides for a second uniform coat on the second surface of the substrate sheet. Both the first uniform coat and the second uniform coat maintain consistent properties irrespective of the type of the substrate sheet or decorative ink layer used, thereby providing, when in contact, a consistent and uniform peel strength. In one embodiment of this aspect, the adhesive layer consists of a pressure-sensitive two-component acrylic microsphere adhesive and the release coating layer consists of a high-gloss ultraviolet-cured acrylic coating.

Having briefly described an overview of embodiments of the present invention, an more detailed discussion of the various embodiments, referring to the various figures, is provided below.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

Illustrative embodiments of the present invention are described in detail below with reference to the attached drawing figures, which are incorporated by reference herein and wherein:

FIG. 1 is an exemplary top perspective view of an unrolled sheet of repositionable self-adhesive giftwrap constructed in accordance with an embodiment of the present invention and having a corner thereof turned up to illustrate both a first surface and a second surface of the giftwrap;

FIG. 2 is an exemplary cross-sectional view of the repositionable self-adhesive giftwrap, illustrating the various layers, in accordance with an embodiment of the present invention;

FIG. 3 is an exemplary perspective view of a sheet of repositionable self-adhesive giftwrap in a rolled configuration, in accordance with an embodiment of the present invention; and

FIG. 4 is an exemplary perspective view of a sheet of repositionable self-adhesive giftwrap applied to an article to create a decoratively-wrapped package, in accordance with an embodiment of the present invention.

### DETAILED DESCRIPTION OF THE INVENTION

The subject matter of the present invention is described with specificity herein to meet statutory requirements. However, the description itself is not intended to limit the scope of the patent. Rather, the inventors have contemplated that the claimed subject matter might also be embodied in other ways, to include different steps or combinations of steps similar to the ones described in this document, in conjunction with other present or future technologies.

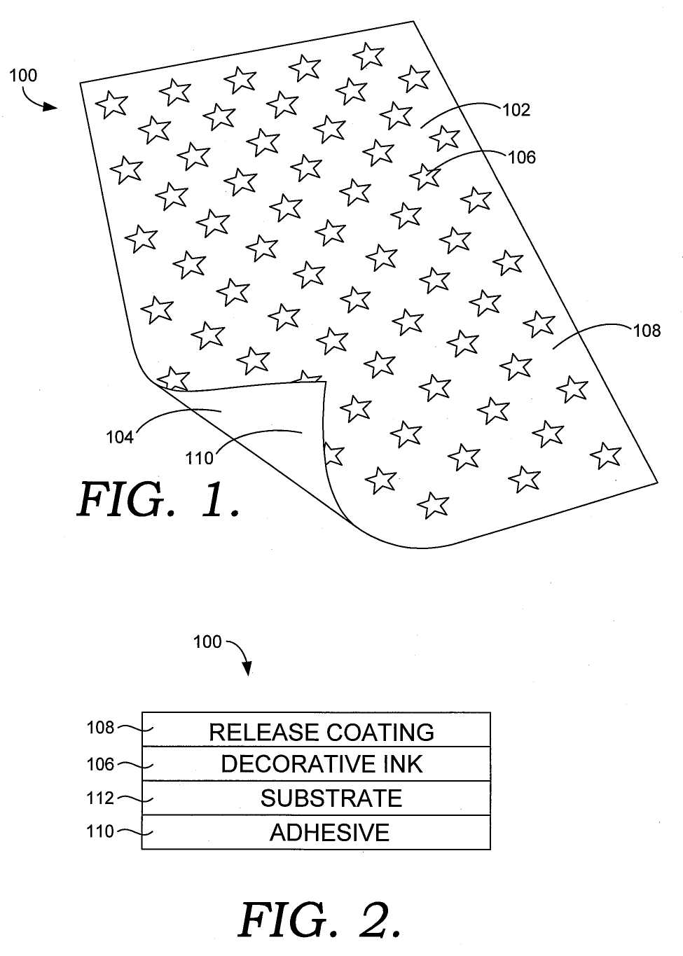

Referring to the drawing figures in general, and initially to FIG. 1 in particular, an exemplary view of an unrolled sheet of repositionable self-adhesive giftwrap is shown. A corner of the giftwrap has been turned up such that both a first upper surface and a second lower surface of the giftwrap, constructed in accordance with an embodiment of the present invention, are illustrated. The giftwrap 100 has a first or upper surface 102 and a second or lower surface 104. The first surface 102 includes a decorative ink layer 106 and a transparent release coating layer 108. Additionally, second surface 104 includes an adhesive layer 110. In embodiments, the decorative ink layer 106 and the coating layer 108 are provided substantially entirely over first surface 102. Similarly, the adhesive layer 110 is provided substantially entirely over second surface 104.

When the giftwrap 100 is applied to an article, for example, to create a package, the adhesive layer 110 of the second surface 104 will adhere to the article. Thus, the giftwrap 100 is configured to be applied to an article without necessitating the use of other fastening devices, such as string or tape. Instead, the adhesive layer 110 of the second surface 104 creates a self-adhesive wrap that is functional without the use of other fastening devices. Additionally, the adhesive layer 110 of second surface 104 is able to adhere to other portions of the giftwrap 100. For instance, as will be discussed in more detail below, when an article is wrapped, it is often necessary to fold portions of the giftwrap 100 over portions of the article that have already been covered with the giftwrap 100, thereby requiring contact between the adhesive layer 110 of the second surface 104 and the contact layer 108 of the first surface 102. In these instances, embodiments of the present invention contemplate that the adhesive layer 110 will selectively adhere to the first surface 102 (and more specifically to the release coating layer 108 of the first surface 102).

Although the adhesive layer 110 will adhere to the release coating layer 108 of the first surface 102, the contact between the surfaces does not create a permanent adhesion. Stated differently, the release coating layer 108 will, in embodiments, be configured so that the adhesive layer 110 of second surface 104 can be removed from the release coating layer 108 of the first surface 102 without removing any of the decorative ink layer 106. The properties of the adhesive layer 110 and its interaction with the release coating layer 108 provide the capability of repositioning during wrapping because the giftwrap 100 can be repositioned without destroying the aesthetic value of decorative ink layer 106 and without compromising the adhesive properties of the adhesive layer 110. Thus, after repositioning the giftwrap 100, the wrapped article will appear as if no repositioning was necessary because there will not be portions of decorative ink layer 106 that have been damaged, nor will the giftwrap 100 be entirely wasted when there has been a need for repositioning.

Additionally, the properties of the contact between the adhesive layer 110 of the second surface 104 and the release coating layer 108 of the first surface 102 provide for effective rolling of the giftwrap during manufacture and for packaging, shipping, and marketing purposes. Without the release coating layer 108, oftentimes self-adhesive giftwrap would be destroyed even before the giftwrap was used by a consumer because the contact between an adhesive and a decorative ink would cause the decorative ink to be damaged upon unrolling the giftwrap. By using the release coating layer 108 of embodiments of the present invention, however, this damage is prevented because the release coating layer 108 acts as a protective barrier to the decorative ink layer 106.

In embodiments, the release coating layer 108 further provides for a uniform coat over first surface 102 of the giftwrap 100 and, similarly, the adhesive layer 110 provides for a uniform coat over second surface 104 of the giftwrap 100 (although uniform, some embodiments of the present invention contemplate that the adhesive is applied in a pattern and may not cover the entirety of second surface 104). For instance, without the release coating layer 108, various substrates and various decorative ink patterns may resulting in varying peel strengths despite using the same adhesive layer 110. In one example, an artistic design calling for low ink coverage may have a different peel strength than an artistic design calling for a high ink coverage, even using the same substrate. Where the substrate is changed, the differences in peel strengths between the various giftwrap designs may be compounded because of varying binders and fillers in the makeup of the paper. Without the release coating layer 108, adjustment of the adhesive used may be necessitated for each type of paper and/or decorative ink design. But, with the release coating layer 108, the various properties of the substrate and the decorative ink layer 106 do not affect the repositionability of the giftwrap 100.

Stated differently, various substrate materials and various decorative ink layers may be used in conjunction with a single adhesive type because the release coating layer 108 ensures a uniform coat, and a uniform contact surface, for the adhesive layer 110 to stick to. In other words, the release coating provides a known, controlled surface for adherence of the adhesive layer. Further, in embodiments, the uniform contact surface between the release coating layer 108 and the adhesive layer 110 has a uniform peel strength. Therefore, not only does the release coating layer 108 provide for repositionability, but also the release coating layer allows manufacturers of self-adhesive giftwrap to use various substrate materials and various decorative inks without having to adjust the properties of the adhesive layer 110. A single adhesive compound is compatible with various substrate materials and various decorative inks because the adhesive layer 110 will contact the release coating layer 108, irrespective of the underlying substrate and decorative ink.

Turning now to FIG. 2, more detailed explanation of the various layers will be discussed with regard to the exemplary cross-sectional view of repositionable self-adhesive giftwrap that is shown, illustrating the various layers, in accordance with an embodiment of the present invention. The cross-section of the giftwrap 100 includes the release coating layer 108, the decorative ink layer 106, a substrate sheet 112, and the adhesive layer 110. In embodiments, the release coating layer 108 may include a variety of coatings. For instance, release coating 108 may be a high-gloss, ultraviolet-cured acrylic coating. In embodiments, the high-gloss ultraviolet coating may contain silicone leveling agents, leaving the surface of release coating 108 with a low surface energy making it difficult to adhere to. In other embodiments, release coating layer 108 may be a water-based gloss coating with silicone leveling. In yet other embodiments, release coating layer 108 may be a waxed release coat. Each of these various embodiments is contemplated by the inventors and within the scope of the present invention.

In various embodiments, the release coating layer 108 may be applied to the substrate sheet 112 and the decorative ink 106 using a number of techniques. For instance, release coating 108 may be applied from a solvent solution, from a water-based emulsion, or from an entirely solid ultraviolet-cured formulation. Each of these applications of the release coating layer 108 are contemplated and within the scope of the present invention.

As previously discussed with reference to FIG. 1, decorative ink 106 is, in various embodiments, applied to the substrate sheet 112. As illustrated, the decorative ink 106 resides between the substrate sheet 112 and the release coating layer 108. In embodiments, substrate sheet 112 may be paper or plastic film. In other embodiments, substrate sheet 112 may be any material suitable for wrapping an article. Similarly, the decorative ink 106 may, in embodiments, be any ink suitable for printing on the substrate sheet 112.

The adhesive layer 110 is configured to adhere the giftwrap 100 to an article. In embodiments, the adhesive layer 110 may include a pressure-sensitive adhesive. For instance, the adhesive layer 110 may consist of a two-component acrylic microsphere adhesive. As will be understood and appreciated by those having skill in the art, in embodiments the adhesive may have a plurality of microspheres and the microspheres may have varying diameters. For instance, in one embodiment, the microsphere diameter may range from 10 to 40 microns. In another embodiment, the range may be narrower, for instance, 20 to 30 microns. In yet another embodiment, the adhesive may include microspheres having a mean diameter of approximately 25 microns. Each of these embodiments, and others, for adhesive microsphere properties are contemplated and within the scope of the present invention. As will be understood and appreciated by those having skill in the art, the elastomeric microspheres limit the contact points between the adhesive layer 110 and the release coating layer 108, moderating the overall tack at a desirable level. It should be noted, however, that the present invention is not limited only to the pressure-sensitive adhesives described herein. Instead, it is contemplated by the inventors and within the scope of the present invention that other adhesives may be used. For instance, an ultra low tack adhesive that does not have microspheres may be used in various embodiments.

Further, in various embodiments of the present invention, the adhesive layer 110 may have various properties. For example, in embodiments, the adhesive layer 110 will include a moderate tack, allowing the giftwrap 100 to retain its removability and repositionability. In other embodiments, the adhesive layer 110 may be configured to withstand various environmental scenarios. For instance, in various embodiments, the adhesive layer 110 may be configured to hold a wrapped article, without unwrapping, in temperatures up to 140° F. Also, in embodiments, the adhesive layer 110 may be configured to maintain stability through heat and humidity alterations, ensuring that the tack is controlled and unchanged during a product life of up to several years. Further, the adhesive layer 110 may be configured to ensure that, once an article has been wrapped with the giftwrap 100, no adhesive residue is left on the article when the giftwrap 100 is removed. In yet other embodiments, the adhesive layer 110 may be configured to retain its aesthetic features, even in the presence of various environmental elements, such as ozone. Thus, as described herein, various adhesives with various properties are contemplated by the inventors and within the scope of the present invention.

In embodiments, the adhesive layer 110 may be applied to the substrate sheet 112 using various techniques. For instance, the adhesive may be applied using printing processes such as, but not limited to, rotogravure or flexography. Also, in various embodiments, the adhesive may be applied with various coating processes such as but not limited to blade coaters, Mayer rods, roll coaters, or air knives. In embodiments, the adhesive layer 110 may be applied in-line along with the decorative ink printing (decorative ink printing may be performed using, in embodiments, rotogravure, flexography, or lithography). Thus, in embodiments, the adhesive is applied along with the decorative ink in a single pass to either a web or sheets of giftwrap.

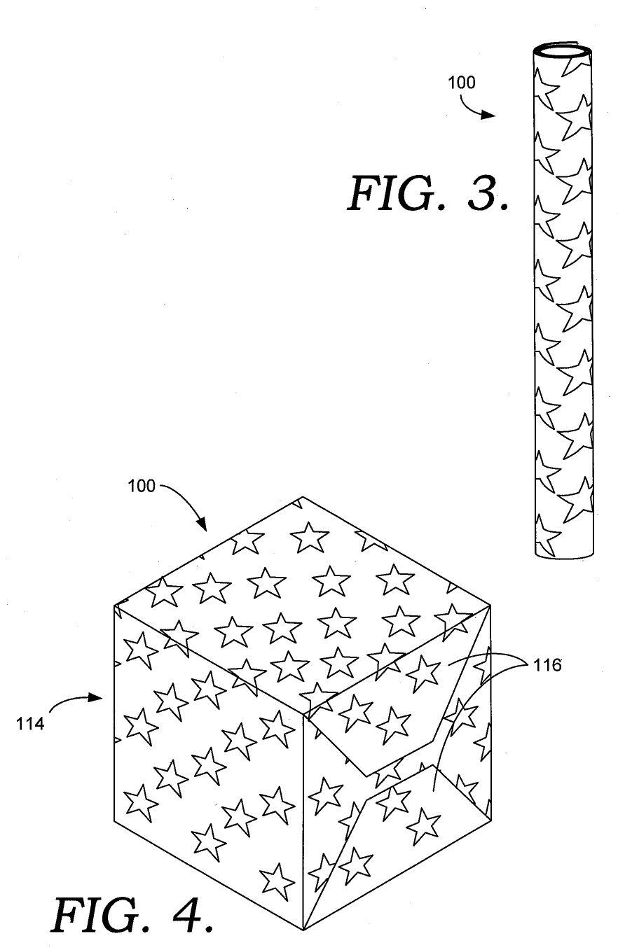

Turning now to FIG. 3, an exemplary view of repositionable self-adhesive giftwrap 100 in a rolled configuration is shown, in accordance with an embodiment of the present invention. As previously discussed, rolled giftwrap 100, when unrolled, will not damage the decorative ink 106 or compromise the adhesiveness of the adhesive layer 110 because of the release coating layer 108.

Turning now to FIG. 4, an exemplary view of repositionable self-adhesive giftwrap 100 applied to an article to create a decoratively-wrapped package 114 is shown, in accordance with an embodiment of the present invention. The package 114, as illustrated, has been wrapped with the giftwrap 100 discussed herein. Because the giftwrap 100 is self-adhesive, there is no need for any separate fastening devices such as string or tape, as previously discussed. Separate fastening devices may, however, be used by the user if so desired. Also, because of the properties of the adhesive layer 110 and the release coating layer 108 previously discussed herein with reference to FIGS. 1 and 2, the decorative ink 106 on the package will not be damaged. Flaps 116 illustrate an instance, other than in a roll, such as the rolled giftwrap 100 of FIG. 3, in which the adhesive layer 110 may contact the release coating layer 108 of the giftwrap 100. Even if the flaps 116 were repositioned during wrapping of the package, the decorative ink 106 would not be damaged and the adhesive properties of the adhesive layer 110 would not be compromised.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the repositionable self-adhesive giftwrap and methods for manufacturing repositionable self-adhesive giftwrap. It will be understood that certain features and sub-combinations are of utility and may be employed without reference to other features and sub-combinations. This is contemplated by and within the scope of the claims.

The invention claimed is:

1. Repositionable self-adhesive giftwrap for decoratively wrapping an article, the giftwrap comprising:
a substrate sheet having a first surface and a second surface, the first surface being an outer surface and the second surface being an inner surface when the giftwrap is applied to the article;
a decorative ink layer applied to the first surface of the substrate sheet;
a release coating layer applied to the first surface of the substrate sheet over the decorative ink layer, such that the decorative ink layer resides between the substrate sheet and the release coating layer; and
an adhesive layer applied to the second surface of the substrate sheet that is configured to adhere the giftwrap to the article,
wherein the release coating layer is configured to allow the adhesive layer of the second surface of the substrate sheet to be removed from the release coating layer of the first surface of the substrate sheet without removing portions of the decorative ink layer when the giftwrap overlaps in such a way that the adhesive layer of the second surface of a first portion of the substrate sheet contacts the release coating of the first surface of a second portion of the substrate sheet.

2. The giftwrap of claim 1, wherein the release coating layer provides for a first uniform coat on the decorative ink layer of the first surface of the substrate sheet, wherein the adhesive layer provides for a second uniform coat on the second surface of the substrate sheet, and wherein both the first uniform coat and the second uniform coat maintain consistent properties irrespective of the type of the substrate sheet or the decorative ink layer used.

3. The giftwrap of claim 2, wherein the first uniform coat and the second uniform coat, when in contact, have a uniform peel strength.

4. The giftwrap of claim 1, wherein the adhesive layer consists of a pressure-sensitive adhesive.

5. The giftwrap of claim 4, wherein the pressure-sensitive adhesive is a two-component acrylic microsphere adhesive.

6. The giftwrap of claim 5, wherein the two-component acrylic microsphere adhesive includes microspheres having a diameter in a range between 10 microns and 40 microns.

7. The giftwrap of claim 1, wherein the adhesive layer consists of an ultra low tack adhesive having no microspheres.

8. The giftwrap of claim 1, wherein the adhesive layer is configured to maintain adherence to the article, once the article has been wrapped with the giftwrap, up to a temperature of 140° F.

9. The giftwrap of claim 1, wherein the adhesive layer is configured to ensure that, once the article has been wrapped with the giftwrap, no adhesive residue is left on the article upon removing the giftwrap from the article.

10. The giftwrap of claim 1, wherein the release coating layer consists of a high-gloss ultraviolet-cured acrylic coating.

11. The giftwrap of claim 1, wherein the release coating layer consists of a water-based high-gloss coating having silicone leveling.

12. The giftwrap of claim 1, wherein the release coating layer consists of a waxed release coat.

13. A method for manufacturing repositionable self-adhesive giftwrap for decoratively wrapping an article, the method comprising:
applying a decorative ink layer to a first surface of a substrate sheet, the substrate sheet having the first surface and a second surface where the first surface is an outer surface and the second surface is an inner surface when the giftwrap is applied to the article;
applying a release coating layer to the first surface of the substrate sheet over the decorative ink layer, such that the decorative ink layer resides between the substrate sheet and the release coating layer; and
applying an adhesive layer to the second surface of the substrate sheet, the adhesive layer configured to adhere the giftwrap to the article,
wherein the release coating layer is configured to allow the adhesive layer of the second surface of the substrate sheet to be removed from the release coating of the first surface of the substrate sheet without removing portions of the decorative ink layer where the giftwrap overlaps in such a way that the adhesive layer of the second surface of a first portion of the substrate sheet contacts the release coating of the first surface of a second portion of the substrate sheet.

14. The method of claim 13, wherein the release coating layer provides for a first uniform coat on the decorative ink layer of the first surface of the substrate sheet and wherein the adhesive layer provides for a second uniform coat on the second surface of the substrate sheet, both the first uniform coat and the second uniform coat maintaining consistent properties irrespective of the type of the substrate sheet or the decorative ink layer used, and wherein the first uniform coat and the second uniform coat, when in contact, have a uniform peel strength.

15. The method of claim 14, wherein the adhesive layer consists of a pressure-sensitive two-component acrylic microsphere adhesive.

16. The method of claim 15, wherein the release coating layer consists of a high-gloss ultraviolet-cured acrylic coating.

17. The method of claim 16, wherein the adhesive layer is applied with rotogravure.

18. The method of claim 17, wherein the adhesive layer is configured to ensure that, once the article has been wrapped with the giftwrap, no adhesive residue is left on the article upon removing the giftwrap from the article.

19. Repositionable self-adhesive giftwrap for decoratively wrapping an article, the giftwrap comprising:
a substrate sheet having a first surface and a second surface, the first surface being an outer surface and the second surface being an inner surface when the giftwrap is applied to the article;
a decorative ink layer applied to the first surface of the substrate sheet;
a release coating layer applied to the first surface of the substrate sheet over the decorative ink layer, such that the decorative ink layer resides between the substrate sheet and the release coating layer; and
an adhesive layer applied to the second surface of the substrate sheet that is configured to adhere the giftwrap to the article,
wherein the release coating layer is configured to allow the adhesive layer of the second surface of the substrate sheet to be removed from the release coating of the first surface of the substrate sheet without removing portions of the decorative ink layer when the giftwrap has been overlapped in such a way that the adhesive layer of the second surface of a first portion of the substrate sheet contacts the release coating of the first surface of a second portion of the substrate sheet,
wherein the release coating layer provides for a first uniform coat on the decorative ink layer of the first surface of the substrate sheet, wherein the adhesive layer provides for a second uniform coat on the second surface of the substrate sheet, and wherein both the first uniform coat and the second uniform coat maintain consistent properties irrespective of the type of the substrate sheet or the decorative ink layer used,
wherein the first uniform coat and the second uniform coat, when in contact, have a uniform peel strength,
wherein the adhesive layer consists of a pressure-sensitive two-component acrylic microsphere adhesive, and
wherein the release coating layer consists of a high-gloss ultraviolet-cured acrylic coating.

20. The giftwrap of claim 19, wherein the pressure-sensitive two-component acrylic microsphere adhesive includes microspheres having a mean diameter of approximately 25 microns.
